(19) United States
(12) Patent Application Publication
(10) Pub. No.: US 2016/0046204 A1
(43) Pub. Date: Feb. 18, 2016

(54) POWER SUPPLY SYSTEM FOR HYBRID VEHICLE AND OPERATION METHOD THEREFOR

(71) Applicant: HANWHA TECHWIN CO., LTD., Gyeongnam (KR)

(72) Inventor: Jungsuk OH, Changwon-si (KR)

(73) Assignee: Hanwha Techwin Co., Ltd., Changwon-si (KR)

(21) Appl. No.: 14/779,994

(22) PCT Filed: Dec. 12, 2013
(86) PCT No.: PCT/KR2013/011520

§ 371 Date: Sep. 25, 2015

(30) Foreign Application Priority Data
Mar. 26, 2013 (KR) 10-2013-0032363

(51) Int. Cl. B60L 11/18

(52) U.S. Cl. CPC B60L 11/1885

(57) ABSTRACT

A power supply system for a hybrid vehicle, which is capable of controlling a fuel cell to operate only in sections in which the fuel cell exhibits optimal efficiency and an operating method thereof. The operating method of operating a power supply system for a hybrid vehicle, which includes a battery and a fuel cell, includes a calculation operation of dividing a route from a departure point to a destination marked in three-dimensional (3D) map information into a plurality of sections, and calculating the amount of power of a fuel cell to be used for a vehicle to drive each of the sections; and a fuel cell operation control operation of controlling the fuel cell to be on or off in each of the plurality of sections when the vehicle starts to drive, based on the state-of-charge of battery, the amount of power output from the fuel cell, and the amount of power of the fuel cell for future use.

### TECHNICAL FIELD

The present invention relates to a power supply system for a hybrid vehicle, which is capable of controlling a fuel cell to operate only in sections in which the fuel cell exhibits optimum efficiency, and an operation method thereof.

### BACKGROUND ART

Recently, mobile devices including a fuel cell as a power source and a motor as a driving power source have been introduced for global environment. The fuel cell is a device that generates power using an electrochemical reaction of hydrogen and oxygen. Vapor is mainly discharged from the fuel cell and thus moving objects using the fuel cell is eco-friendly.

However, when only the fuel cell is used as a power source of a mobile device, all of loads of the mobile device are charged by the fuel cell. Thus, the performance of the mobile device may be lowered in an operating area in which the efficiency of the fuel cell is low. In a high-speed operating area requiring a high voltage or when a load is suddenly applied to the mobile device, an output voltage sharply decreases and thus a sufficient voltage is not applied to a driving motor. Thus, an acceleration performance of the mobile device is lowered.

To solve the problems, a hybrid power supply system has been developed. The hybrid power supply system includes not only a fuel cell as a main power source but also a battery which is a power storage means as an additional power source for supplying power for driving a motor.

A vehicle including such a hybrid power supply system is disclosed in Korean laid-open patent publication No. 2003-0017513, entitled “Power Supply Apparatus Using Fuel Cell and Rechargeable Power Storage, Method of Controlling the Same, and Power Output Apparatus and Vehicle Including Power Supply Apparatus”. Here, driving of a fuel cell is, however, controlled according to a desired amount of output power. Thus, the fuel cell is driven in low-efficiency sections regardless of optimum efficiency thereof.

### DETAILED DESCRIPTION OF THE INVENTION

### Technical Problem

The present invention provides a power supply system for a hybrid vehicle, which is capable of controlling a fuel cell of the hybrid vehicle to operate only in sections in which the fuel cell exhibits optimum efficiency, based on three-dimensional (3D) map information including geographic information from a departure point to a destination, and an operation method thereof.

### Technical Solution

According to an aspect of the present invention, a power supply system for a hybrid vehicle including a battery and a fuel cell includes a calculation unit for dividing a route from a departure point to a destination marked in three-dimensional (3D) map information into a plurality of sections, and calculating an amount of power of the fuel cell for future use for the vehicle to drive each of the plurality of sections; and a fuel cell operation control unit for controlling the fuel cell to be on or off in each of the plurality of sections when the vehicle starts to drive, based on a state-of-charge (SoC) of the battery, an amount of power output from the fuel cell, and the amount of power of the fuel cell for future use.

According to an embodiment of the present invention, the power supply system may further include a memory for storing the 3D map information, driving data, and the amount of power of the fuel cell for future use, wherein the driving data includes state information of the battery and the fuel cell and state information of the vehicle.

According to an embodiment of the present invention, the calculation unit may calculate the amount of power of the fuel cell for future use according to a speed of the vehicle, based on distance information and information regarding slopes of each of the plurality of sections, which are included in the 3D map information.

According to an embodiment of the present invention, the fuel cell operation control unit may control the fuel cell to be off when the amount of power output from the fuel cell is greater than the amount of power of the fuel cell for future use in a state in which the state-of-charge of the battery is equal to or greater than a first value.

According to an embodiment of the present invention, the fuel cell operation control unit may control the fuel cell to be on when the amount of power output from the fuel cell is less than the amount of power of the fuel cell for future use in a state in which the state-of-charge of the battery is equal to or greater than a first value.

According to an embodiment of the present invention, the fuel cell operation control unit may maintain a present state of the fuel cell when the amount of power output from the fuel cell is greater than amount of power of the fuel cell for future use in a state in which the state-of-charge of the battery is between a first value and a second value.

According to an embodiment of the present invention, the fuel cell operation control unit may control the fuel cell to be on when the amount of power output from the fuel cell is less than the amount of power of the fuel cell for future use in a state in which the state-of-charge of the battery is between a first value and a second value.

According to an embodiment of the present invention, the fuel cell operation control unit may control the fuel cell to be on when the state-of-charge of the battery is less than or equal to a second value.

According to an embodiment of the present invention, when the vehicle is not driven, the fuel cell operation control unit may control the fuel cell to be off regardless of the state-of-charge of the battery.

According to an embodiment of the present invention, when the driving of the vehicle ends, the fuel cell operation control unit may update the amount of power of the fuel cell for future use, which is stored in the memory, to reflect an amount of power of the fuel cell used while the vehicle drives.

According to another aspect of the present invention, a method of operating a power supply system for a hybrid vehicle including a battery and a fuel cell includes a calculation operation of dividing a route from a departure point to a destination marked in three-dimensional (3D) map information into a plurality of sections, and calculating an amount of power of the fuel cell for future use for the vehicle to drive each of the plurality of sections; and a fuel cell operation control operation of controlling the fuel cell to be on or off in each of the plurality of sections when the vehicle starts to drive, based on a state-of-charge of the battery, an amount of power output from the fuel cell, and the amount of power of the fuel cell for future use.

According to an embodiment of the present invention, the method may further include loading the 3D map information stored in a memory; and obtaining geographic information from the departure point to the destination from the 3D map information.

According to an embodiment of the present invention, the calculation operation may include dividing the route from the departure point to the destination into the plurality of sections; and calculating the amount of power of the fuel cell for future use according to a speed of the vehicle, based on distance information and information regarding slopes of each of the plurality of sections, which are included in the 3D map information.

According to an embodiment of the present invention, the fuel cell operation control operation may include controlling the fuel cell to be on when the amount of power output from the fuel cell is less than the amount of power of the fuel cell for future use in a state in which the state-of-charge of the battery is equal to or greater than a first value.

According to an embodiment of the present invention, the fuel cell operation control operation may include maintaining a present state of the fuel cell when the amount of power output from the fuel cell is greater than the amount of power of the fuel cell for future use in a state in which the state-of-charge of the battery is between a first value and a second value.

According to an embodiment of the present invention, the fuel cell operation control operation may include controlling the fuel cell to be on when the amount of power output from the fuel cell is less than the amount of power of the fuel cell for future use in a state in which the state-of-charge of the battery is between a first value and a second value.

According to an embodiment of the present invention, the fuel cell operation control operation may include controlling the fuel cell to be on when the state-of-charge of the battery is less than or equal to a second value.

According to an embodiment of the present invention, the fuel cell operation control operation may include controlling the fuel cell to be off regardless of the state-of-charge of the battery when the vehicle is not driven.

According to an embodiment of the present invention, when the driving of the vehicle ends, the method may further include updating the amount of power of the fuel cell for future use to reflect an amount of power of the fuel cell used while the vehicle drives.

### Advantageous effects

As described above, according to the present invention, a problem of a fuel cell that takes a long time to be started may be solved by determining the amount of power for future use beforehand, based on three-dimensional (3D) map information including geographic information from a departure point to a destination. Also, a fuel cell may be operated only in sections in which the fuel cell exhibits optimum efficiency other than in sections in which the fuel cell exhibits low efficiency by determining the amount of power for future use beforehand, based on the 3D map information including the geographic information from the departure point to the destination. Furthermore, the amount of power for future use may be predicted based on the 3D map information including the geographic information from the departure point to the destination, thereby stably managing power of a battery.

### BRIEF DESCRIPTION OF THE DRAWINGS

FIG. 1 is a block diagram of a power supply system for a hybrid vehicle according to an embodiment of the present invention.

FIG. 2 is a detailed diagram of a memory of FIG. 1.

FIG. 3 is a detailed diagram of a control unit of FIG. 1.

FIG. 4 illustrates a driving section from a departure point to a destination marked in each of two-dimensional (2D) map information and three-dimensional (3D) map information.

FIG. 5 illustrates a future-use power amount calculation unit of FIG. 3.

FIG. 6 is a flowchart of a method of operating a power supply system for a hybrid vehicle according to an embodiment of the present invention.

FIG. 7 is a flowchart of a method of controlling a fuel cell to be on/off, which is included in the method of FIG. 6.

### BEST MODE FOR CARRYING OUT THE INVENTION

According to one aspect of the present invention, there is provided a power supply system for a hybrid vehicle that includes a battery and a fuel cell. The power supply system includes a calculation unit configured to divide a route from a departure point to a destination marked in three-dimensional (3D) map information into a plurality of sections, and calculate the amount of power of the fuel cell for future use for the hybrid vehicle to drive each of the sections; and a fuel cell operation control unit configured to control the fuel cell to be on or off in each of the plurality of sections when the hybrid vehicle starts to drive, based on the state-of-charge (SoC) of the battery, the amount of power output from the fuel cell, and the amount of power of the fuel cell for future use.

Mode of the invention

The present invention may be embodied in many different forms and performed in various embodiments. Thus, exemplary embodiments are illustrated in the drawings and described in detail in the detailed description. However, the present invention is not limited to these embodiments and should be understood to cover all modifications, equivalents, and alternatives falling within the technical idea and scope of the invention. In the following description, well-known functions or constructions are not described in detail if it is determined that they would obscure the invention due to unnecessary detail.

It will be understood that, although the terms ‘first’, ‘second’, ‘third’, etc., may be used herein to describe various elements, components, regions, layers and/or sections, these elements, components, regions, layers and/or sections should not be limited by these terms. These terms are only used to distinguish one element, component, region, layer or section from another element, component, region, layer or section.

The terminology used herein is for the purpose of describing particular embodiments only and is not intended to be limiting of the invention. As used herein, the singular forms ‘a’, ‘an’ and ‘the’ are intended to include the plural forms as well, unless the context clearly indicates otherwise. It will be further understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof.

The present invention may be represented using functional block components and various operations. Such functional blocks may be realized by any number of hardware and/or software components configured to perform specified functions. For example, the present invention may employ various integrated circuit components, e.g., memory, processing elements, logic elements, look-up tables, and the like, which may carry out a variety of functions under control of at least one microprocessor or other control devices. As the elements of the present invention are implemented using software programming or software elements, the present invention may be implemented with any programming or scripting language such as C, C++, Java, assembler, or the like, including various algorithms that are any combination of data structures, processes, routines or other programming elements. Functional aspects may be realized as an algorithm executed by at least one processor. Furthermore, the present invention may employ conventional techniques for electronics configuration, signal processing and/or data processing. The terms ‘mechanism’, ‘element’, ‘means’, ‘configuration’, etc. are used broadly and are not limited to mechanical or physical embodiments. These terms should be understood as including software routines in conjunction with processors, etc.

Hereinafter, exemplary embodiments of the present invention will be described in detail with reference to the accompanying drawings. In the drawings, the same reference numerals are assigned to the same or corresponding elements and are not redundantly described here.

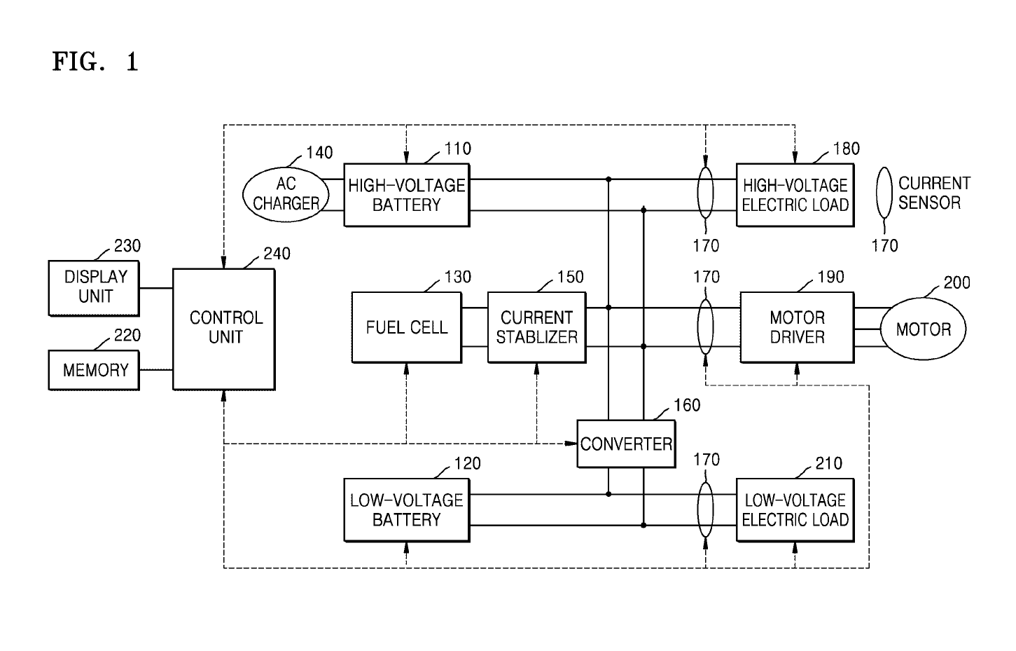

FIG. 1 is a block diagram of a power supply system for a hybrid vehicle according to an embodiment of the present invention.

Referring to FIG. 1, the power supply system for a hybrid vehicle includes a high-voltage battery 110, a low-voltage battery 120, a fuel cell 130, an alternate-current (AC) charger 140, a current stabilizer 150, a converter 160, a current sensor 170, a high-voltage electric load 180, a motor driver 190, a motor 200, a low-voltage electric load 210, a memory 220, a display unit 230, and a control unit 240.

The high-voltage battery 110 is charged by the AC charger 140, and drives the high-voltage electric load 180 and the motor 200 by using a voltage output from the high-voltage battery 110. Here, when the power supply system is installed in a vehicle, the high-voltage electric load 180 may be, for example, a power steering wheel requiring high voltage.

The voltage output from the high-voltage battery 110 is converted into a low voltage by the converter 160 and used to charge the low-voltage battery 120. The low-voltage battery 120 drives the low-voltage electric load 210. Here, the low-voltage load 210 may be an electronic device for use in a vehicle (such as an audio system or an air conditioner), for example, when the power supply system is installed in the vehicle.

The fuel cell 130 functions as a power source, together with the high-voltage battery 110 and the low-voltage battery 120. It takes about ten minutes or more to start driving the fuel cell 130. Power of the fuel cell 130 is output to the current stabilizer 150. The current stabilizer 150 blocks unnecessary currents among high currents output from the high-voltage battery 110, and controls the fuel cell 130 to stably output current.

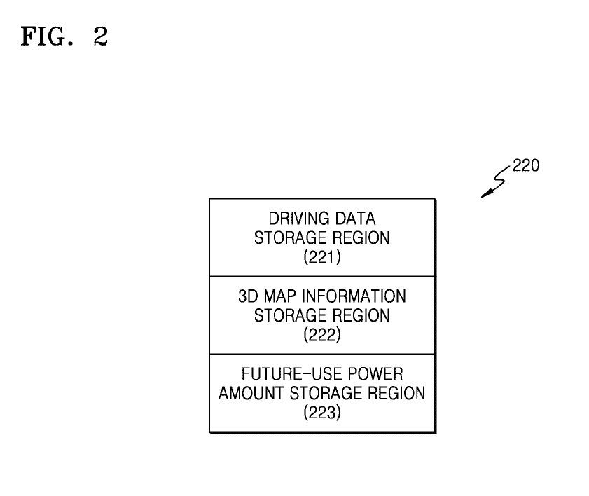

The memory 220 stores vehicle driving data, three-dimensional (3D) map information, and the amount of power for future use. FIG. 2 is a detailed diagram of the memory 220 of FIG. 1. Referring to FIG. 2, the memory 220 includes a driving data storage region 221, a 3D map information storage region 222, and a future-use power amount storage region 223. Driving data stored in the driving data storage region 221 may be an operational error of the fuel cell 130 representing a stack that does not operate due to the operational error among a plurality of stacks of the fuel cell 130, the remains of a fuel, a state-of-charge (SoC) of the high-voltage battery 110, a load capability table, etc. 3D map information stored in the 3D map information storage region 222 may be a 3D map provided from Google or 3D map information provided from the V-World. A future-use power amount stored in the future-use power amount storage region 223 may be an amount of power of the fuel cell 130 required when the vehicle drives a driving section under control of the control unit 240 which will be described below. In the future-use power amount storage region 223, information regarding a section that the vehicle traveled and the amount of power of the fuel cell 130 that was actually used in this section may be updated and stored.

The display unit 230 displays the 3D map information, a departure point and a destination that are input by a user, and a driving section from the departure point to the destination. Furthermore, the display unit 230 displays a current location of a vehicle and geographical features of surrounding areas when the vehicle is driving. The display unit 230 may not only display the 3D map information but also perform a digital multimedia broadcasting (DMB) function, a function of displaying the state of the inside of the vehicle, etc. The display unit 230 may include at least one among a liquid crystal display (LCD), an organic light-emitting diode (OLED), an electrophoretic digital display (EPD), a flexible display, and a 3D display.

The control unit 240 controls overall operations of the system, and checks a result of sensing current supplied to the high-voltage electric load 180, the motor driver 190, and the low-voltage electric load 210, which is performed by the current sensor 170, and controls the operations of the high-voltage battery 110, the low-voltage battery 120, the fuel cell 130, the current stabilizer 150, and the converter 160, based on the result of sensing the current.

In the present embodiment, the control unit 240 loads the 3D map information stored in memory 220 and displays it on the display unit 230, receives information regarding a departure point and a destination that are input by a user, calculates the amount of power of the fuel cell 130 for future use when a vehicle will drive from the departure point to the destination, and controls the fuel cell 130 to be on or off when the vehicle starts to drive, based on the state-of-charge (SoC) of the high-voltage battery 110, the amount of power output from the fuel cell 130, and the amount of power of the fuel cell 130 for future use.

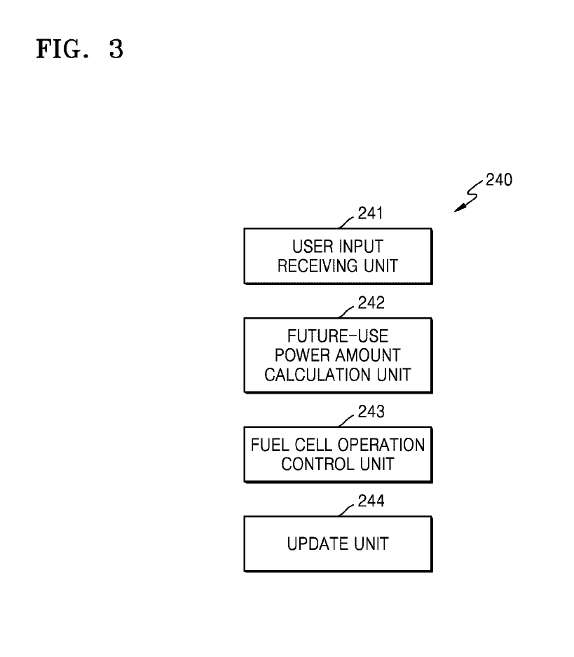

FIG. 3 is a detailed diagram of the control unit 240. Referring to FIG. 3, the control unit 240 includes a user input receiving unit 241, a future-use power amount calculation unit 242, a fuel cell operation control unit 243, and an update unit 244.

The user input receiving unit 241 receives the information regarding the departure point and the destination, which are input by the user, from the 3D map information displayed on the display unit 230.

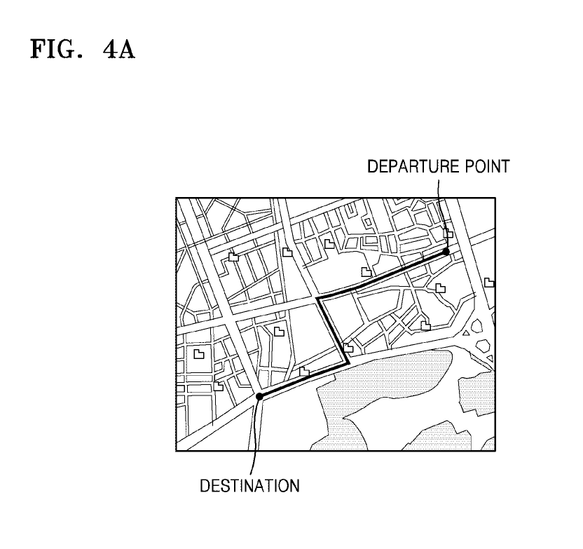

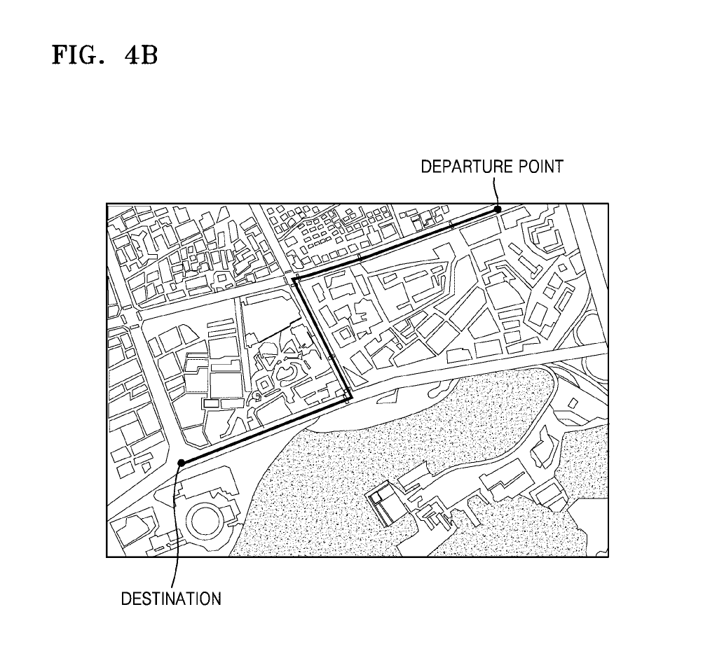

FIG. 4 illustrates a driving section from a departure point to a destination marked in each of two-dimensional (2D) map information and 3D map information. In FIG. 4, FIG. 4(a) illustrates the driving section from the departure point to the destination marked in the 2D map information. The 2D map information of FIG. 4(a) does not include geographic information regarding the driving section, i.e., information regarding slopes (e.g., the heights of roads) included in the driving section to the destination. Thus, it is difficult to precisely calculate the amount of power of the fuel cell 130 for future use, and errors are large even when the amount of power of the fuel cell 130 for future use is calculated. FIG. 4(b) illustrates the driving section from the departure point to the destination marked in the 3D map information. The 3D map information of FIG. 4(b) includes geographic information regarding the driving section, i.e., information regarding slopes (e.g., the heights of roads) included in the driving section to the destination. Thus, the amount of power of the fuel cell 130 for future use may be precisely calculated.

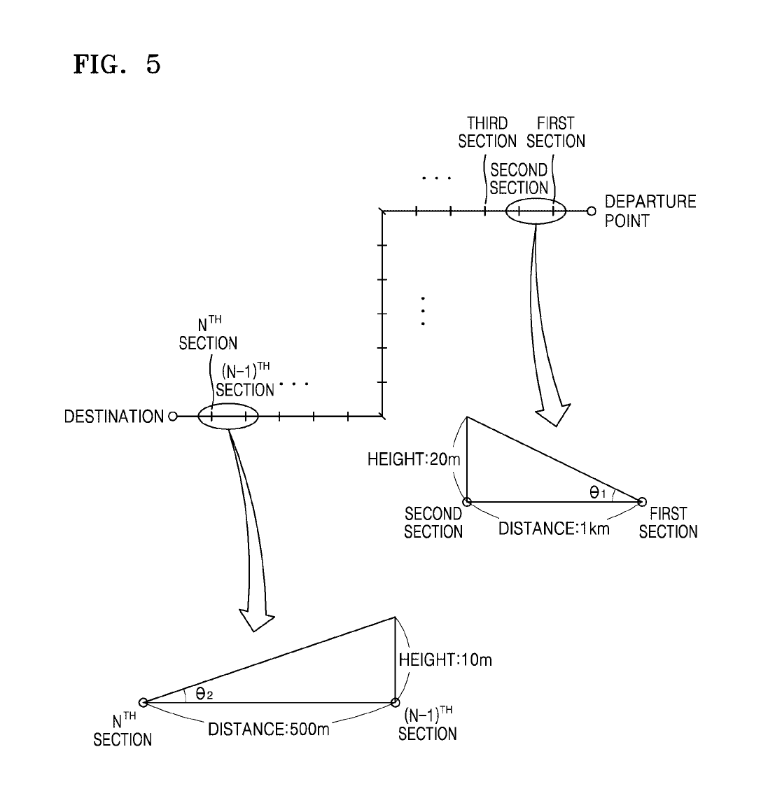

The future-use power amount calculation unit 242 calculates the amount of power of the fuel cell 130 for future use when a vehicle drives from the departure point to the destination marked in the 3D map information. FIG. 5 illustrates the future-use power amount calculation unit 242 of FIG. 3. Referring to FIG. 5, the future-use power amount calculation unit 242 divides a route from a departure point to a destination marked in 3D map information into a plurality of sections (e.g., a first section to an N^{th} section). The future-use power amount calculation unit 242 calculates the amount of power of the fuel cell 130 for future use according to the speed of a vehicle, based on the distances to the plurality of sections and information regarding slopes in the plurality of sections.

As illustrated in FIG. 5, the distance between the first section and the second section is 1 km, and the height between the first section and the second section, i.e., the height above the sea level, is 20 m. Thus, a climbing angle θ₁ is present as information regarding a slope between the first section and the second section. Here, the climbing angle θ₁ represents the angle formed by a direction in which the vehicle is driving and the horizontal plane. Thus, a driving section from the first section to the second section is an uphill driving section. Thus, the future-use power amount calculation unit 242 may calculate the amount of power of the fuel cell 130 for future use according to the speed of a vehicle, based on distance information and the climbing angle 0₁ as information regarding a slope between the first section and the second section. Here, the amount of power of the fuel cell 130 for future use is calculated, based on distance information and information regarding slopes of each of the sections, and the speed of the vehicle. In addition, the type of the vehicle and the number of passengers may be further taken into account to more precisely calculate the amount of power of the fuel cell 130 for future use.

As illustrated in FIG. 5, the distance between the (N−1)^{th} section and the N^{th} section is 500 m, and the height between the (N−1)^{th} section and the N^{th} section, i.e., the height above the sea level, is 10 m. Thus, a climbing angle θ₂ is present as information regarding a slope between the (N−1)^{th} section and the N^{th} section. A driving section from the (N−1)^{th} section to the N^{th} section is a downhill driving section. Thus, the future-use power amount calculation unit 242 may calculate the amount of power of the fuel cell 130 for future use according to the speed of the vehicle, based on distance information and the climbing angle θ₂ as information regarding a slope between the (N−1)^{th} section and the N^{th} section. Similarly, the amount of power of the fuel cell 130 for future use is calculated based on distance information and information regarding slopes of each of the sections, and the speed of the vehicle. In addition, the type of the vehicle and the number of the number of passengers may be further taken into account to more precisely calculate the amount of power of the fuel cell 130 for future use.

Here, when a section among the plurality of sections (the first section to the N^{th} section) is identical to a section that a vehicle drove and information of which is stored in the memory 220, the future-use power amount calculation unit 242 may set the amount of power for future use for the section as the amount of power for future use of the section, the information of which is stored in the memory 220. For example, when a third section is identical to another section, the information of which is stored in the memory 220, the amount of power for future use for the third section may be set as the amount of power for future use of the other section, the information of which is stored in the memory 220. As described above, it is possible to reduce a time required for the future-use power amount calculation unit 242 to calculate the amount of power for future use for each of the plurality of sections.

The future-use power amount calculation unit 242 stores the amount of power of the fuel cell 130 for future use in the future-use power amount storage region 223 of the memory 220 when a vehicle drives from the departure point to the destination.

When the vehicle starts to drive, the fuel cell operation control unit 243 controls the vehicle to drive in only sections in which the fuel cell 130 exhibits optimum efficiency, based on the state-of-charge (SoC) of the high-voltage battery 110, the amount of power output from the fuel cell 130, and the amount of power of the fuel cell 130 for future use, which is stored in the memory 220.

If the state-of-charge (SoC) of the high-voltage battery 110 in each of the plurality of sections is equal to or greater than a first value, the fuel cell operation control unit 243 controls the fuel cell 130 to be off when the amount of power output from the fuel cell 130 is larger than the amount of power for future use, which is stored in the memory 221, and controls the fuel cell 130 to be on when the amount of power output from the fuel cell 130 is smaller than the amount of power for future use, which is stored in the memory 221. Here, the first value may represent a case in which the state-of-charge (SoC) of the high-voltage battery 110 is, for example, 90% or more.

If the state-of-charge (SoC) of the high-voltage battery 110 in each of the plurality of sections is between the first value and a second value, the fuel cell operation control unit 243 maintains a present state of the fuel cell 130 when the amount of power output from the fuel cell 130 is larger than the amount of power for future use, which is stored in the memory 221. That is, the fuel cell operation control unit 243 maintains an ‘on’ state of the fuel cell 130 when the fuel cell 130 is ‘on’ and maintains an ‘off’ state of the fuel cell 130 when the fuel cell 130 is ‘off’. When the amount of power output from the fuel cell 130 is smaller than the amount of power for future use, which is stored in the memory 221, the fuel cell operation control unit 243 controls the fuel cell 130 to be on. That is, the fuel cell operation control unit 243 maintains a present state of the fuel cell 130 when the fuel cell 130 is on, and changes the fuel cell 130 to be on when the fuel cell 130 is off. Here, the second value may represent a case in which the state-of-charge (SoC) of the high-voltage battery 110 is, for example, 60%.

The fuel cell operation control unit 243 controls the fuel cell 130 to be on when the state-of-charge (SoC) of the high-voltage battery 110 in each of the plurality of sections is less than or equal to the second value.

When the driving of the vehicle ends, the update unit 244 updates, in the future-use power amount storage region 223 of the memory 220, the amount of power of the fuel cell 130 that was actually used while the vehicle drove. When the amount of power of the fuel cell 130 is updated, an update ratio may be adjusted. For example, the amount of power for future use, which has been stored in the future-use power amount storage region 223 of the memory 220, may be finally updated to reflect 50% of the amount of power that was actually used. Also, the update unit 244 may update driving data generated while the vehicle drove in the driving data storage region 221 of the memory 220. Here, the driving data may be updated not only after the driving of the vehicle ends but also while the vehicle is driving.

As described above, a problem of the fuel cell 130 that takes a long time to be started may be solved by determining the amount of power of the fuel cell 130 for future use beforehand, based on 3D map information including geographic information from a departure point to a destination. Also, the fuel cell 130 may be driven only in sections in which the fuel cell 130 exhibits optimum efficiency other than sections in which the efficiency of the fuel cell 130 is low by determining the amount of power of the fuel cell 130 for future use beforehand, based on the 3D map information including the geographic information from the departure point to the destination. Furthermore, the power of the batteries 110 and 120 may be stably managed by predicting the amount of power for future use, based on the 3D map information including the geographic information from the departure point to the destination.

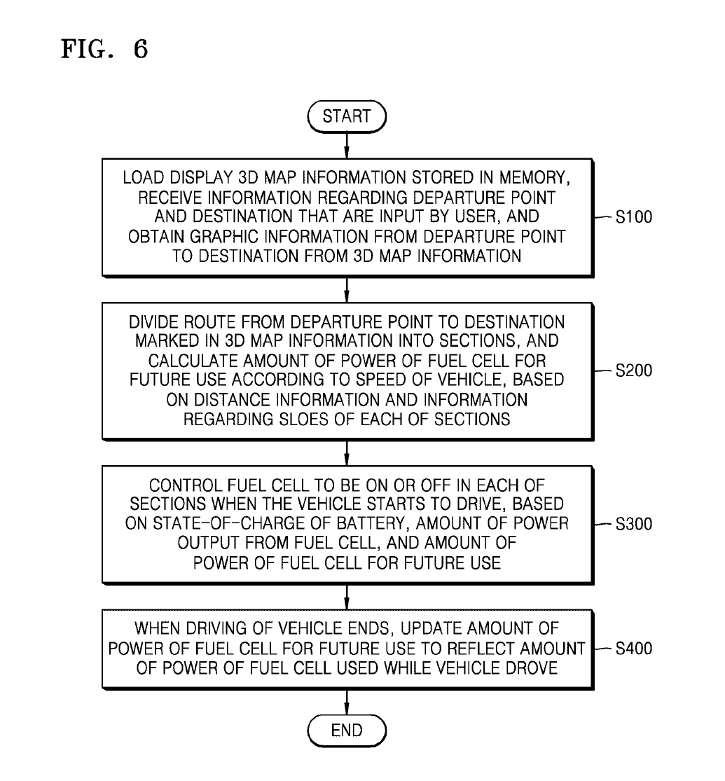

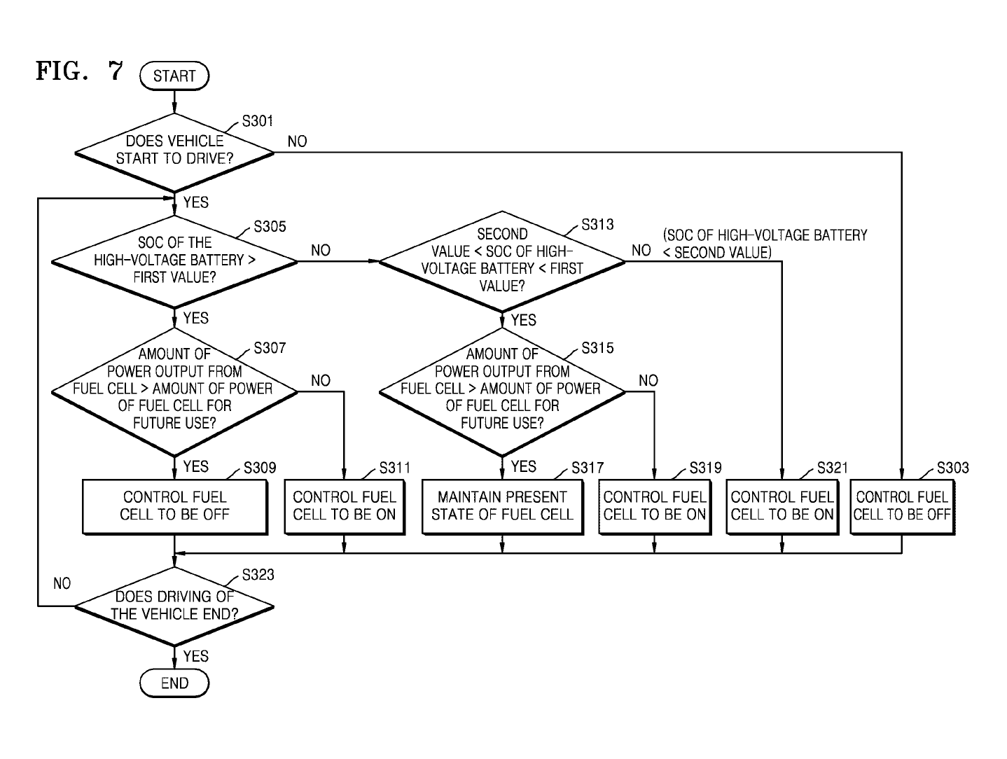

FIG. 6 is a flowchart of a method of operating a power supply system for a hybrid vehicle according to an embodiment of the present invention. FIG. 7 is a flowchart of a method of controlling a fuel cell to be on/off, which is included in the method of FIG. 6. The method of operating a power supply system for a hybrid vehicle according to an embodiment of the present invention may be performed by the control unit 240 together with the other elements of the power supply system as illustrated in FIG. 1. In the following description, a description of the methods of FIGS. 6 and 7 that is the same as the descriptions of FIGS. 1 to 5 is omitted here.

Referring to FIG. 6, the control unit 240 loads and displays 3D map information stored in the memory 220, receives information regarding a departure point and a destination that are input by a user, and obtains graphic information from the departure point to the destination from the 3D map information (operation S100). When the obtaining of the graphic information from the 3D map information is completed, the control unit 240 divides a route from the departure point to the destination marked in the 3D map information into a plurality of sections, and calculates the amount of power of the fuel cell 130 for future use according to the speed of a vehicle, based on distance information and information regarding slopes in each of the plurality of sections (operation S200). Although the control unit 240 calculates the amount of power of the fuel cell 130 for future use, based on distance information and information regarding slopes of each of the plurality of sections and the speed of the vehicle, the type of the vehicle and the number of passengers may be further taken into account to more precisely calculate the amount of power of the fuel cell 130 for future use. Here, when a section among the plurality of sections is identical to a section that the vehicle drove and information of which is stored in the memory 220, the control unit 240 may set the amount of power for future use for the section as the amount of power for future use, which is stored in the memory 220. By setting the amount of power for future use as described above, a time required to calculate the amount of power for future use for each of the plurality of sections, performed by the control unit 240, may be decreased. After the amount of power of the fuel cell 130 for future use is calculated, the control unit 240 stores a result of calculating the amount of power of the fuel cell 130 for future use in the memory 220.

When the calculation and storing of the amount of power of the fuel cell 130 for future use are completed, the control unit 240 determines whether the vehicle starts to drive, and controls the fuel cell 130 to be on or off in each of the plurality of sections when the vehicle starts to drive, based on the state-of-charge (SoC) of the high-voltage battery 110, the amount of power output from the fuel cell 130, and the amount of power of the fuel cell 130 for future use (operation S300). FIG. 7 is a detailed flowchart of a method of controlling the fuel cell 130 to be on/off, performed by the control unit 240.

Referring to FIG. 7, the control unit 240 determines whether a vehicle starts to drive (operation S301), and controls the fuel cell 130 to be off when the vehicle is in a pause state (operation S303).

However, when the vehicle starts to drive, the control unit 240 checks the state-of-charge (SoC) of the high-voltage battery 110 in each of the plurality of sections, and determines whether the state-of-charge (SoC) of the high-voltage battery 110 in each of the plurality of sections is equal to or greater than a first value (operation S305). Here, the first value may represent a case in which the state-of-charge (SoC) of the high-voltage battery 110 is, for example, 90%.

When the state-of-charge (SoC) of the high-voltage battery 110 is equal to or greater than the first value, the control unit 240 determines whether the amount of power output from the fuel cell 130 is greater than the amount of power of the fuel cell 130 for future use, which is stored in the memory 220 (operation S307).

When the state-of-charge (SoC) of the high-voltage battery 110 is equal to or greater than the first value and the amount of power output from the fuel cell 130 is greater than the amount of power of the fuel cell 130 for future use, the control unit 240 controls the fuel cell 130 to be off by transmitting an OFF command to the fuel cell 130 (operation S309).

However, the state-of-charge (SoC) of the high-voltage battery 110 is equal to or greater than the first value and the amount of power output from the fuel cell 130 is less than the amount of power of the fuel cell 130 for future use, the control unit 240 controls the fuel cell 130 to be on by transmitting an ON command to the fuel cell 130 (operation S311).

Next, the control unit 240 determines whether the state-of-charge (SoC) of the high-voltage battery 110 in each of the plurality of sections is between the first value and a second value (operation S313). Here, the first value may represent a case in which the state-of-charge (SoC) of the high-voltage battery 110 is, for example, 90%, and the second value may represent a case in which the state-of-charge (SoC) of the high-voltage battery 110 is, for example, 60%.

When the state-of-charge (SoC) of the high-voltage battery 110 in each of the plurality of sections is between the first value and the second value, the control unit 240 determines whether the amount of power output from the fuel cell 130 is greater than the amount of power of the fuel cell 130 for future use, which is stored in the memory 220 (operation S315).

When the state-of-charge (SoC) of the high-voltage battery 110 is between the first value and the second value and the amount of power output from the fuel cell 130 is greater than the amount of power of the fuel cell 130 for future use, the control unit 240 maintains a present state of the fuel cell 130 by transmitting a command to maintain the present state to the fuel cell 130 (operation S317). Here, the maintaining of the present state of the fuel cell 130 means that the fuel cell 130 is controlled to be in an OFF state when the fuel cell 130 is off, and controlled to be in an ON state when the fuel cell 130 is on.

However, when the state-of-charge (SoC) of the high-voltage battery 110 is between the first value and the second value and the amount of power output from the fuel cell 130 is less than the amount of power of the fuel cell 130 for future use, the control unit 240 controls the fuel cell 130 to be on by transmitting the ON command to the fuel cell 130 (operation S319). Here, the control unit 240 maintains the ON state of the fuel cell 130 when the fuel cell 130 is on, and switches the fuel cell 130 to the ON state when the fuel cell 130 is off.

Next, the control unit 240 checks the state-of-charge (SoC) of the high-voltage battery 110 in each of the plurality of sections, and controls the fuel cell 130 to be on by transmitting the ON command to the fuel cell 130 regardless of the amount of power output from the fuel cell 130 and the amount of power of the fuel cell 130 for future use when the state-of-charge (SoC) of the high-voltage battery 110 in each of the plurality of sections is less than or equal to the second value (operation S321).

Then, the control unit 240 determines whether the driving of the vehicle ends (operation S323), and performs operation S305 when the vehicle is driving and performs operation S400 of FIG. 6 when the driving of the vehicle ends.

Referring back to FIG. 6, when the driving of the vehicle ends, the control unit 240 updates the amount of power of the fuel cell 130 for future use to reflect the amount of power of the fuel cell 130 used while the vehicle drove (operation S400). When the amount of power of the fuel cell 130 for future use is updated, an update ratio may be adjusted. Also, the control unit 240 may update driving data generated while the vehicle drove in the memory 220.

The present invention can be embodied as computer-readable code in a computer-readable medium. The computer-readable medium may be any recording apparatus capable of storing data that is read by a computer system.

Examples of the computer-readable medium include a read-only memory (ROM), a random access memory (RAM), a compact disc (CD)-ROM, a magnetic tape, a floppy disk, an optical data storage device, and so on. Also, the computer-readable medium may be embodied as a carrier wave (e.g., transmission of data using the Internet). The computer-readable medium can be distributed among computer systems that are interconnected through a network, and the present invention may be stored and implemented as computer readable code in the distributed system. Functional programs, code, and code segments for performing the present invention can be easily derived by programmers in the technical field to which the present invention pertains.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A power supply system for a hybrid vehicle which includes a battery and a fuel cell, the power supply system comprising:
a calculation unit for dividing a route from a departure point to a destination marked in three-dimensional (3D) map information into a plurality of sections, and calculating an amount of power of the fuel cell for future use for the vehicle to drive each of the plurality of sections; and
a fuel cell operation control unit for controlling the fuel cell to be on or off in each of the plurality of sections when the vehicle starts to drive, based on a state-of-charge (SoC) of the battery, an amount of power output from the fuel cell, and the amount of power of the fuel cell for future use.

2. The power supply system of claim 1, further comprising a memory for storing the 3D map information, driving data, and the amount of power of the fuel cell for future use, wherein the driving data includes state information of the battery and the fuel cell and state information of the vehicle.

3. The power supply system of claim 1, wherein the calculation unit calculates the amount of power of the fuel cell for future use according to a speed of the vehicle, based on distance information and information regarding slopes of each of the plurality of sections, which are included in the 3D map information.

4. The power supply system of claim 1, wherein the fuel cell operation control unit controls the fuel cell to be off when the amount of power output from the fuel cell is greater than the amount of power of the fuel cell for future use in a state in which the state-of-charge of the battery is equal to or greater than a first value.

5. The power supply system of claim 1, wherein the fuel cell operation control unit controls the fuel cell to be on when the amount of power output from the fuel cell is less than the amount of power of the fuel cell for future use in a state in which the state-of-charge of the battery is equal to or greater than a first value.

6. The power supply system of claim 1, wherein the fuel cell operation control unit maintains a present state of the fuel cell when the amount of power output from the fuel cell is greater than amount of power of the fuel cell for future use in a state in which the state-of-charge of the battery is between a first value and a second value.

7. The power supply system of claim 1, wherein the fuel cell operation control unit controls the fuel cell to be on when the amount of power output from the fuel cell is less than the amount of power of the fuel cell for future use in a state in which the state-of-charge of the battery is between a first value and a second value.

8. The power supply system of claim 1, wherein the fuel cell operation control unit controls the fuel cell to be on when the state-of-charge of the battery is less than or equal to a second value.

9. The power supply system of claim 1, wherein, when the vehicle is not driven, the fuel cell operation control unit controls the fuel cell to be off regardless of the state-of-charge of the battery.

10. The power supply system of claim 3, wherein, when the driving of the vehicle ends, the fuel cell operation control unit updates the amount of power of the fuel cell for future use, which is stored in the memory, to reflect an amount of power of the fuel cell used while the vehicle drives.

11. A method of operating a power supply system for a hybrid vehicle which includes a battery and a fuel cell, the method comprising:
a calculation operation of dividing a route from a departure point to a destination marked in three-dimensional (3D) map information into a plurality of sections, and calculating an amount of power of the fuel cell for future use for the vehicle to drive each of the plurality of sections; and
a fuel cell operation control operation of controlling the fuel cell to be on or off in each of the plurality of sections when the vehicle starts to drive, based on a state-of-charge of the battery, an amount of power output from the fuel cell, and the amount of power of the fuel cell for future use.

12. The method of claim 11, further comprising:
loading the 3D map information stored in a memory; and
obtaining geographic information from the departure point to the destination from the 3D map information.

13. The method of claim 12, wherein the calculation operation comprises:
dividing the route from the departure point to the destination into the plurality of sections; and
calculating the amount of power of the fuel cell for future use according to a speed of the vehicle, based on distance information and information regarding slopes of each of the plurality of sections, which are included in the 3D map information.

14. The method of claim 11, wherein the fuel cell operation control operation comprises controlling the fuel cell to be off when the amount of power output from the fuel cell is greater than the amount of power of the fuel cell for future use in a state in which the state-of-charge of the battery is equal to or greater than a first value.

15. The method of claim 11, wherein the fuel cell operation control operation comprises controlling the fuel cell to be on when the amount of power output from the fuel cell is less than the amount of power of the fuel cell for future use in a state in which the state-of-charge of the battery is equal to or greater than a first value.

16. The method of claim 11, wherein the fuel cell operation control operation comprises maintaining a present state of the fuel cell when the amount of power output from the fuel cell is greater than the amount of power of the fuel cell for future use in a state in which the state-of-charge of the battery is between a first value and a second value.

17. The method of claim 11, wherein the fuel cell operation control operation comprises controlling the fuel cell to be on when the amount of power output from the fuel cell is less than the amount of power of the fuel cell for future use in a state in which the state-of-charge of the battery is between a first value and a second value.

18. The method of claim 11, wherein the fuel cell operation control operation comprises controlling the fuel cell to be on when the state-of-charge of the battery is less than or equal to a second value.

19. The method of claim 11, wherein, when the vehicle is not driven, the fuel cell operation control operation comprises controlling the fuel cell to be off regardless of the state-of-charge of the battery.

20. The method of claim 11, when the driving of the vehicle ends, further comprising updating the amount of power of the fuel cell for future use to reflect an amount of power of the fuel cell used while the vehicle drives.
